(19) United States
(12) Patent Application Publication
(10) Pub. No.: US 2021/0062924 A1
(43) Pub. Date: Mar. 4, 2021

(54) WATER OUTLET MEMBER OF FAUCET

(71) Applicant: Xiamen Lota International Co., Ltd., Xiamen (CN)

(72) Inventors: Qiang HUANG, Xiamen (CN); Yanyan WANG, Xiamen (CN); Chuanbao ZHU, Xiamen (CN)

(21) Appl. No.: 17/005,422

(22) Filed: Aug. 28, 2020

(30) Foreign Application Priority Data
Aug. 30, 2019 (CN) 201910816400.2

(51) Int. Cl. F16K 11/22; F16K 31/60; F16K 27/02

(52) U.S. Cl. CPC F16K 11/22; F16K 27/003; F16K 27/0263; F16K 31/602

(57) ABSTRACT

A water outlet member of a faucet comprises a mounting passage, a valve assembly, and a press cover. The mounting passage comprises a limiting element. The valve assembly is configured to be assembled to the mounting passage from an entrance of the mounting passage, and the limiting element limits axial movement of the valve assembly. The press cover covers the entrance of the mounting passage, and the press cover is configured to enable the valve assembly to be axially fixed. The valve assembly comprises a valve seat body, and the valve seat body comprises a valve part and a tube part. A portion of the tube part adjacent to an outlet of the mounting passage is circumferentially disposed with a first sealing member abutting the mounting passage.

### RELATED APPLICATIONS

This application claims priority to Chinese patent application number 201910816400.2, filed on Aug. 30, 2019, which is incorporated herein by reference.

### FIELD OF THE DISCLOSURE

The present disclosure relates to a field of bathroom fixtures, and more particularly relates to a water outlet member of a faucet.

### BACKGROUND OF THE DISCLOSURE

A typical faucet comprises a water outlet member, which is roughly H-shaped. The water outlet member comprises two water passing parts disposed on a left side and a right side and a connection part connected between the two water passing parts. Bottom ends of the two water passing parts respectively have a water inlet, usually one is a cold water inlet and the other is a hot water inlet, and water can respectively flow through an internal flow passage of the two water passing parts. The two water passing parts are each mainly configured to provide an area in which a valve body is installed and positioned, and the valve bodies are respectively controlled by a rotation of a handle. A middle section of the connection part usually comprises at least one water outlet configured to be connected to a water outlet pipe of the faucet.

When the existing valve bodies are disposed in the two water passing units, multiple components are assembled in the water outlet member one by one, and finally a handle bushing is applied to abut a valve core. This method makes assembly difficult. Moreover, when the valve core is assembled, axial positioning of the valve core is not accurate and needs to be adjusted by the user.

Chinese utility model patent CN206860955U of the applicant discloses a water outlet element of a faucet, which comprises a separate water inlet pipe, and sealing ring structures are disposed on an upper part and a lower part of the water inlet pipe to prevent water leakage. However, when a valve core is assembled, if components of the valve core are assembled in the water outlet member one by one according to existing techniques, it is not easy to axially position the water inlet pipe and to ensure that the water inlet pipe is fixed. If the water inlet pipe moves axially, water leakage likely occurs.

### BRIEF SUMMARY OF THE DISCLOSURE

The present disclosure provides a water outlet member of a faucet, which can realize convenient assembly and prevent water leakage, thereby overcoming the deficiencies of the existing techniques.

In order to solve the aforementioned technical problem, the present disclosure provides a water outlet member of a faucet.

A water outlet member of a faucet comprises a mounting passage, a valve assembly, and a press cover. The mounting passage comprises a limiting element. The valve assembly is configured to be assembled to the mounting passage from an entrance of the mounting passage, and the limiting element limits axial movement of the valve assembly. The press cover covers the entrance of the mounting passage, and the press cover is configured to enable the valve assembly to be axially fixed. The valve assembly comprises a valve seat body, and the valve seat body comprises a valve part and a tube part. A portion of the tube part adjacent to an outlet of the mounting passage is circumferentially disposed with a first sealing member abutting the mounting passage.

In a preferred embodiment, the tube part is integrally molded with the valve part.

In a preferred embodiment, a portion of the valve seat body adjacent to an inlet of the mounting passage is circumferentially disposed with a second sealing member abutting the mounting passage.

In a preferred embodiment, the mounting passage comprises a first mounting passage and a second mounting passage. The valve part is disposed in the first mounting passage, and the tube part is disposed in the second mounting passage.

In a preferred embodiment, an inner diameter of the first mounting passage is larger than an inner diameter of the second mounting passage, and a connection between the first mounting passage and the second mounting passage is disposed with the limiting element.

In a preferred embodiment, the limiting element is a limiting step, and an outer diameter of the valve part is larger than an outer diameter of the tube part. A connection between the valve part and the tube part is disposed with a coupling step, and the coupling step abuts the limiting step.

In a preferred embodiment, the valve assembly further comprises a valve core disposed in the valve part, and an inner side of the valve part comprises a water inlet passage. The water inlet passage is in communication with a valve core inlet of the valve core.

In a preferred embodiment, the valve part comprises a valve mounting groove, and the valve core is disposed in the valve mounting groove. A bottom wall of the valve mounting groove comprises a valve groove inlet, and the valve groove inlet is in communication with the water inlet passage.

In a preferred embodiment, the valve part further comprises a valve groove outlet in communication with the valve mounting groove, and a valve core outlet of the valve core is in communication with the valve groove outlet.

In a preferred embodiment, a portion of the valve core above the valve groove outlet is circumferentially disposed with a third sealing member, and the third sealing member abuts an inner wall of the valve mounting groove.

In a preferred embodiment, the water outlet member of the faucet further comprises a water outlet and a water outlet passage in communication with the water outlet. The water outlet passage is in communication the valve groove outlet.

In a preferred embodiment, the valve groove inlet extends to define an accommodating peripheral wall along a periphery of the valve groove inlet. The valve assembly further comprises a valve sealing member disposed in the accommodating peripheral wall and an elastic member is disposed between and abuts the valve sealing member and the bottom wall of the valve mounting groove. The valve sealing member is disposed between and abuts the valve core and the accommodating peripheral wall.

Compared with the existing techniques, the technical solution has the following advantages.

1. The mounting passage of the water outlet member of the faucet comprises a limiting element configured to axially position the valve assembly.

2. The valve part and the tube part of the valve seat body are integrally molded. When an injection molding process is used, the production is simple and the cost is low.

3. The valve part and the tube part of the valve seat body are integrally molded, so there is no risk of water leakage from the connection between the valve part and the tube part.

4. The valve part and the tube part of the valve seat body adjacent to the inlet and the outlet of the mounting passage are respectively disposed with sealing members to prevent water from flowing into a gap between the valve seat body and the mounting passage.

5. After the valve assembly is axially fixed, when an external water source is connected and the tube part is pressed by the external water source, the tube part will not move axially, thereby preventing water leakage.

### BRIEF DESCRIPTION OF THE DRAWINGS

FIG. 1 illustrates a cross-sectional view of a water outlet member of a faucet of an embodiment of the present disclosure;

FIG. 2 illustrates an enlarged cross-sectional view of a first portion of the water outlet member of the embodiment of the present disclosure;

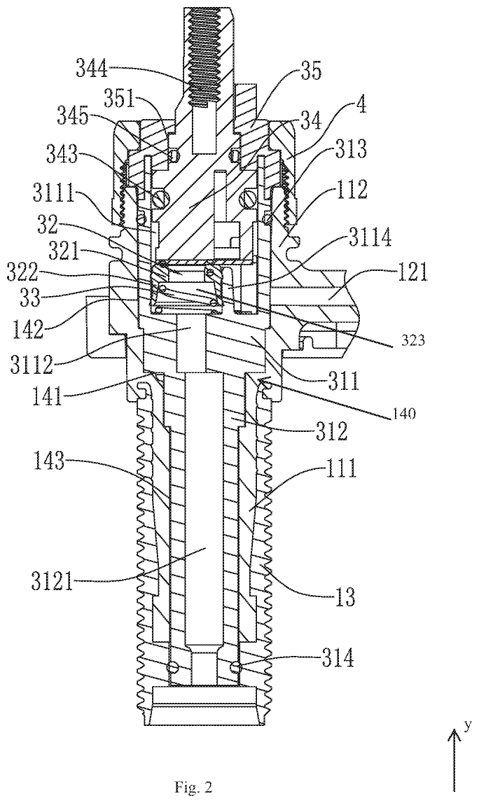

FIG. 3 illustrates an exploded perspective view of a second portion of the water outlet member of the embodiment of the present disclosure;

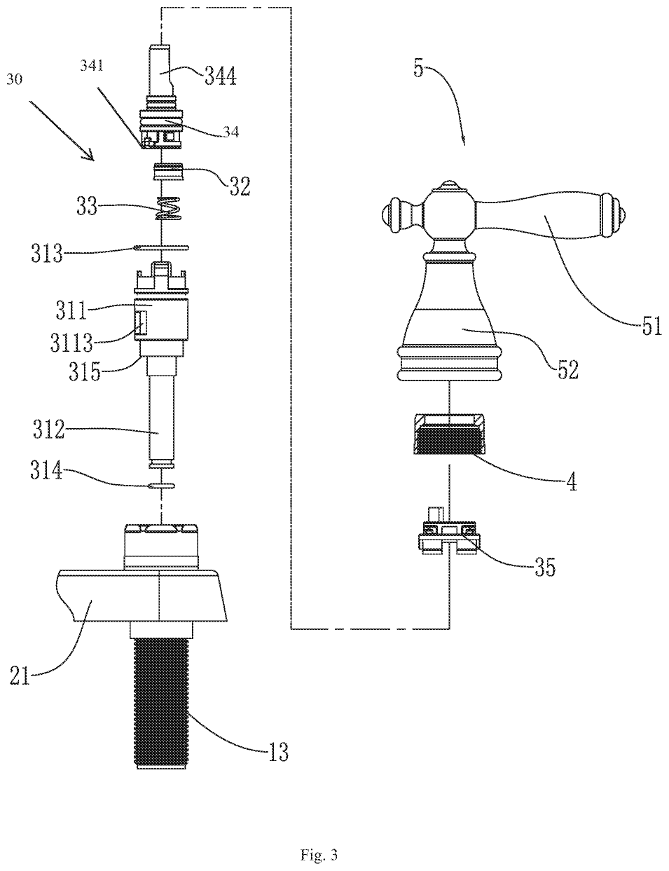

FIG. 4 illustrates a side view of a valve seat body of the embodiment of the present disclosure; and

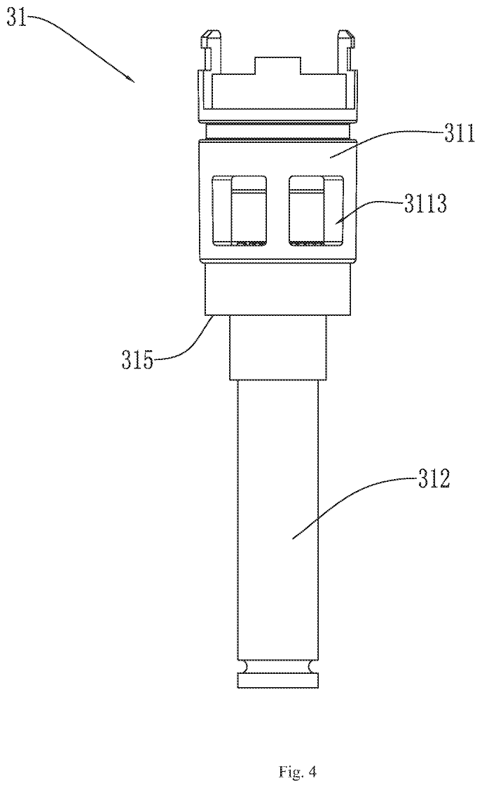

FIG. 5 illustrates a cross-sectional view of the valve seat body of the embodiment of the present disclosure.

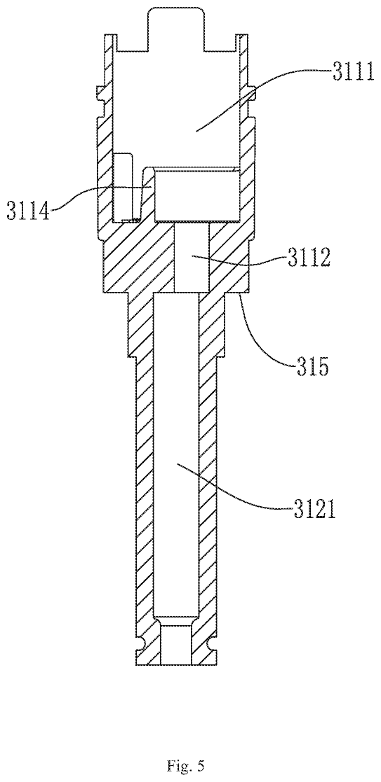

### DETAILED DESCRIPTION OF THE EMBODIMENTS

The present disclosure will be further described below in combination with the accompanying drawings and embodiments.

Hereinafter, certain directional terms are used to describe the drawings, such as “inner”, “outer”, “above”, “below”, and other directional terms, will be understood to have their normal meanings and refer to the directions of the drawings taken normally. Unless otherwise specified, the directional terms described in this specification basically follow conventional directions understood by those skilled in the art.

The terms “first”, “second”, and similar terms used in the present disclosure do not indicate any order, quantity, or importance in the present disclosure, but are configured to distinguish one part from other parts.

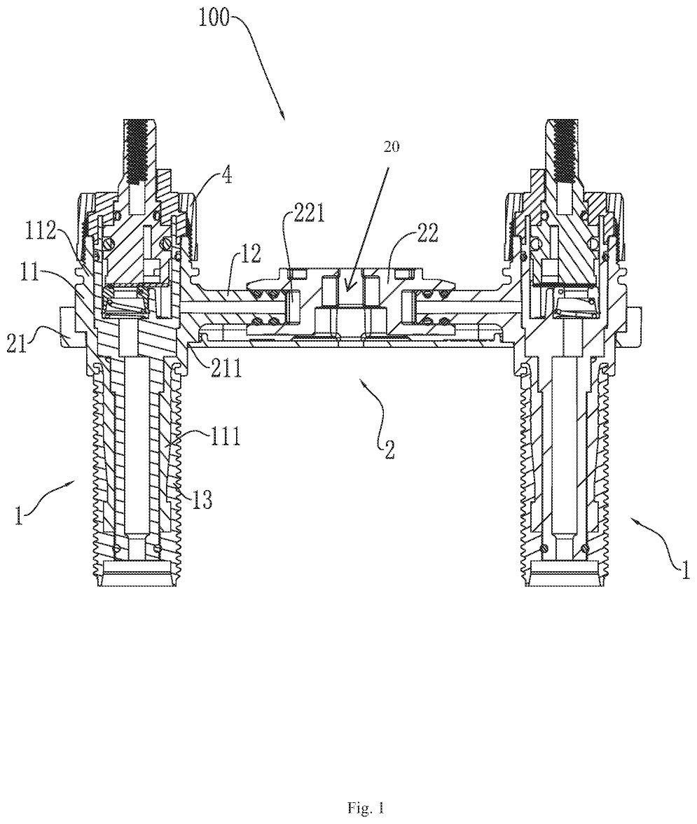

Referring to FIG. 1, a water outlet member 100 used in a faucet comprises two water flowing parts 1 and a connection part 2 connected between the two water flowing parts 1. The two water flowing parts 1 each comprises a seat body 11 and a water outlet tube 12 protruding from a middle portion of the seat body 11. The seat body 11 defines a lower seat body 111 extending a distance vertically downward from the middle portion of the seat body 11. The two water flowing parts 1 each further comprises a mounting part 13 surrounding an outer peripheral wall of the lower seat body 111, and the mounting part 13 comprises copper. In this embodiment, the seat body 11 comprises a plastic material. The seat body 11 is connected to the mounting part 13 using dual-shot injection molding. An outer circumferential wall of the mounting part 13 comprises an external thread, and the external thread is used to pass through a counter to which the water outlet member 100 is to be installed to fixedly dispose the water outlet member 100 on the counter.

The seat body 11 further defines an upper seat body 112 extending a distance vertically upward from the middle portion of the seat body 11. An axis (e.g., a y-axis) of the upper seat body 112 and an axis (e.g., a y-axis) of the lower seat body 111 are coaxial. An extending distance (e.g., a longest dimension) of the upper seat body 112 is smaller than an extending distance (e.g., a longest dimension) of the lower seat body 111. An outer circumferential wall of a vertical end of the upper seat body 112 comprises an external thread disposed along a circumferential direction of the upper seat body 112.

The two water flowing parts 1 each further comprises a mounting passage 140 extending along and penetrating the seat body 11, and the mounting passage 140 comprises a limiting element 141. The mounting passage 140 comprises a first mounting passage 142 extending along the upper seat body 112 and a second mounting passage 143 extending along the lower seat body 111, and an inner diameter of the first mounting passage 142 is larger than an inner diameter of the second mounting passage 143. A connection position between the first mounting passage 142 and the second mounting passage 143 is disposed with the limiting element 141, and the limiting element 141 is a limiting step. A water outlet passage 121 is further disposed in the water outlet tube 12 and is in communication with the first mounting passage 142, and the water outlet passage 121 penetrates the water outlet tube 12.

The connection part 2 comprises a connection body 21, and the connection body 21 comprises one or more connection holes 211 configured to enable the two water flowing parts 1 to pass through. Middle portions of the two water flowing parts 1 can be placed on the one or more connection holes 211 to prevent the two water flowing parts 1 from continuing to move axially. The connection part 2 further comprises a connection cover 22. The connection cover 22 comprises two cover holes 221 disposed at intervals with an intersection angle of 180 degrees, and the connection cover 22 further comprises a water outlet 20 that is in communication with the two cover holes 221. The two cover holes 221 are configured to receive the water outlet tubes 12, and an outer circumferential side of each of the water outlet tubes 12 can be disposed with a sealing ring configured to abut a corresponding one of the two cover holes 221 to enable the water outlet passages 121 to be in communication with the water outlet 20. When the two water flowing parts 1 are connected to the connection part 2, the water outlet tubes 12 are in communication with the two cover holes 221, and the connection cover 22 is connected to the connection body 21 by a threaded bolt.

It should be noted that the two water flowing parts 1 are connected to the connection part 2 to define the water outlet member 100. In some simple replacement embodiments, the two water flowing parts 1 and the connection part 2 can also be integrally molded. In some simple replacement embodiments, the water outlet passage 121 of each of the two water flowing parts 1 can also be prepared using an arc-shaped conduit. The construction of the water outlet member 100 can vary provided that the water outlet member 100 comprises the mounting passages 140.

The water outlet member 100 also comprises a valve assembly 30 disposed in each of the mounting passages 140. The valve assembly 30 comprises a valve seat body 31, and the valve seat body 31 extends from an inlet of the mounting passage 140 to an outlet of the mounting passage 140. A portion of the valve seat body 31 adjacent to the inlet of the mounting passage 140 is circumferentially disposed with a second sealing member 313, and a portion of the valve seat body 31 adjacent to the outlet of the mounting passage 140 is circumferentially disposed with a first sealing member 314. The second sealing member 313 abuts the first mounting passage 142, and the first sealing member 314 abuts the second mounting passage 143. The second sealing member 313 and the first sealing member 314 are configured to ensure that water does not flow into a gap between the valve seat body 31 and the mounting passage 140. In this embodiment, and the second sealing member 313 and the first sealing member 314 are O-shaped sealing rings.

The valve seat body 31 comprises a valve part 311 disposed in the first mounting passage 142 and a tube part 312 disposed in the second mounting passage 143. The valve part 311 and the tube part 312 are integrally molded. The valve part 311 is disposed with the second sealing member 313, and the tube part 312 is disposed with the first sealing member 314. An outer diameter of the valve part 311 is larger than an outer diameter of the tube part 312. A connection between the valve part 311 and the tube part 312 is disposed with a coupling step 315 abutting the limiting element 141, and an inner side of the tube part 312 extends to define a water inlet passage 3121 (e.g., a through water inlet passage). The water inlet passage 3121 is configured to be connected to an external water source. The valve part 311 comprises a valve mounting groove 3111, and a bottom wall of the valve mounting groove 3111 comprises a valve groove inlet 3112 being in communication with the water inlet passage 3121. The valve groove inlet 3112 extends to define an accommodating peripheral wall 3114 along a periphery of the valve groove inlet 3112. The valve assembly 30 further comprises a valve sealing member 32 disposed in the accommodating peripheral wall 3114 and an elastic member 33 abutting the valve sealing member 32 and the bottom wall of the valve mounting groove 3111. The elastic member 33 is a spring, and the valve sealing member 32 abuts the accommodating peripheral wall 3114. The valve assembly 30 further comprises a valve core 34, the valve core 34 is disposed in the valve mounting groove 3111. The valve core 34 comprises a valve core inlet and a valve core outlet. When water flows out of the valve core 34, the valve sealing member 32 abuts a periphery of the valve core inlet. The valve core inlet is configured to rotate about an axis of the valve mounting groove 3111. When in a water-proof state (e.g., water does not flow out of the valve core 34), the valve sealing member 32 abuts the bottom surface of the valve core 34. In some embodiments, the valve core 34 comprises a bottom plate 341 disposed on a bottom surface of the valve core 34. The bottom plate 341 comprises the valve core inlet, and the valve sealing member 32 abuts the bottom plate 341. In this embodiment, the valve sealing member 32 comprises an annular body 321 comprising a water hole 323 and a peripheral body 322 gradually extending from a periphery of the annular body 321. The annular body 321 is configured to abut the peripheral of the valve core inlet, and the peripheral body 322 abuts the accommodating peripheral wall 3114. The water from the water inlet passage 3121 flows through the water hole 323 and flows into the valve core inlet.

The valve part 311 also comprises a valve groove outlet 3113 disposed on an outer peripheral wall of the valve part 311 and in communication with the valve mounting groove 3111. The valve groove outlet 3113 corresponds to and is in communication with the water outlet passage 121 of the water outlet tube 12. The valve core outlet is in communication with the valve mounting groove 3111. The water from the valve core outlet flows into the valve mounting groove 3111, then flows into the valve groove outlet 3113, and then flows from the valve groove outlet 3113 into the water outlet passage 121.

A portion of the valve core 34 above the valve groove outlet 3113 is circumferentially disposed with a third sealing member 343. The third sealing member 343 abuts an inner wall of the valve mounting groove 3111, and the third sealing member 343 is configured to prevent the water from overflowing out of the valve mounting groove 3111. The third sealing member 343 is an O-ring.

The valve assembly 30 further comprises a valve cover body 35 covering an inlet of the valve mounting groove 3111, and the valve cover body 35 is connected to the inlet of the valve mounting groove 3111 using a lock fastener. In some simple replacement embodiments, the valve cover body 35 is connected to the inlet of the valve mounting groove 3111 can be fixed using other methods. The valve cover body 35 is disposed on an entrance of the valve mounting groove 3111 to abut the valve seat body 31 to enable the coupling step 315 to abut the limiting step, and the valve seat body 31 is axially positioned. In addition, the valve cover body 35 also abuts the valve core 34, so that the valve core 34 is properly positioned.

The valve cover body 35 further comprises a shaft hole 351 extending along an axial direction of the valve core 34 and penetrating the valve cover body 35. The valve core 34 further comprises a control shaft 344 protruding along an axial direction of the valve core 34. The control shaft 344 is connected to the bottom plate 341, and the control shaft 344 rotates to drive the bottom plate 341 to rotate. The valve core inlet follows the control shaft 344 to rotate, and the control shaft 344 is configured to control water outflow volume of the valve core 34. The control shaft 344 passes through the shaft hole 351. The control shaft 344 further comprises a fourth sealing member 345 extending in a circumferential direction of the control shaft 344, and the fourth sealing member 345 abuts the shaft hole 351 to prevent water from flowing out.

The water outlet member 100 further comprises a press cover 4 covering an entrance of the first mounting passage 142. The press cover 4 is screwed to an outer thread of the upper seat body 112, and the press cover 4 abuts the valve cover body 35 of the valve assembly 30 to prevent the valve assembly 30 from moving axially, so that the valve assembly 30 is axially fixed.

The water outlet member 100 further comprises a handle assembly 5 connected to the control shaft 344. The handle assembly 5 comprises a handle 51 and a decorative cover 52. The decorative cover 52 is disposed on an outer side the upper seat body 112, and the handle is connected to the control shaft 344 to control the valve core 34.

It will be apparent to those skilled in the art that various modifications and variation can be made in the present disclosure without departing from the spirit or scope of the invention. Thus, it is intended that the present disclosure cover the modifications and variations of this invention provided they come within the scope of the appended claims and their equivalents.

What is claimed is:

1. A water outlet member of a faucet, comprising:
a mounting passage,
a valve assembly, and
a press cover, wherein:
the mounting passage comprises a limiting element,
the valve assembly is configured to be assembled to the mounting passage from an entrance of the mounting passage,
the limiting element limits axial movement of the valve assembly,
the press cover covers the entrance of the mounting passage,
the press cover is configured to enable the valve assembly to be axially fixed,
the valve assembly comprises a valve seat body,
the valve seat body comprises a valve part and a tube part, and
a portion of the tube part adjacent to an outlet of the mounting passage is circumferentially disposed with a first sealing member abutting the mounting passage.

2. The water outlet member of the faucet according to claim 1, wherein the tube part is integrally molded with the valve part.

3. The water outlet member of the faucet according to claim 2, wherein a portion of the valve seat body adjacent to an inlet of the mounting passage is circumferentially disposed with a second sealing member abutting the mounting passage.

4. The water outlet member of the faucet according to claim 3, wherein:
the mounting passage comprises a first mounting passage and a second mounting passage,
the valve part is disposed in the first mounting passage, and
the tube part is disposed in the second mounting passage.

5. The water outlet member of the faucet according to claim 4, wherein:
an inner diameter of the first mounting passage is larger than an inner diameter of the second mounting passage, and
a connection between the first mounting passage and the second mounting passage is disposed with the limiting element.

6. The water outlet member of the faucet according to claim 5, wherein:
the limiting element is a limiting step,
an outer diameter of the valve part is larger than an outer diameter of the tube part,
a connection between the valve part and the tube part is disposed with a coupling step, and
the coupling step abuts the limiting step.

7. The water outlet member of the faucet according to claim 2, wherein:
the valve assembly further comprises a valve core disposed in the valve part,
an inner side of the valve part comprises a water inlet passage, and
the water inlet passage is in communication with a valve core inlet of the valve core.

8. The water outlet member of the faucet according to claim 7, wherein:
the valve part comprises a valve mounting groove,
the valve core is disposed in the valve mounting groove,
a bottom wall of the valve mounting groove comprises a valve groove inlet, and
the valve groove inlet is in communication with the water inlet passage.

9. The water outlet member of the faucet according to claim 8, wherein.
the valve part further comprises a valve groove outlet in communication with the valve mounting groove, and
a valve core outlet of the valve core is in communication with the valve groove outlet.

10. The water outlet member of the faucet according to claim 9, wherein.
a portion of the valve core above the valve groove outlet is circumferentially disposed with a third sealing member, and
the third sealing member abuts an inner wall of the valve mounting groove.

11. The water outlet member of the faucet according to claim 10, further comprising:
a water outlet, and
a water outlet passage in communication with the water outlet, wherein:
the water outlet passage is in communication the valve groove outlet.

12. The water outlet member of the faucet according to claim 8, wherein:
the valve groove inlet extends to define an accommodating peripheral wall along a periphery of the valve groove inlet,
the valve assembly further comprises a valve sealing member disposed in the accommodating peripheral wall and an elastic member is disposed between and abuts the valve sealing member and the bottom wall of the valve mounting groove, and
the valve sealing member is disposed between and abuts the valve core and the accommodating peripheral wall.
